(19) United States
(12) Patent Application Publication
(10) Pub. No.: US 2009/0117224 A1
(43) Pub. Date: May 7, 2009

(54) Hydrating beverages and method

(75) Inventor: Robert A. Robergs, Tijeras, NM (US)

Correspondence Address: HITCHCOCK EVERT LLP, P.O. BOX 131709, DALLAS, TX, 75313-1709, US

(73) Assignee: Hydration Beverage Companies, LLC

(21) Appl. No.: 11/981,979

(22) Filed: Nov. 1, 2007

(51) Int. Cl. A23L 2/52; A23L 2/38

(52) U.S. Cl. 426/2; 426/541; 426/590; 426/74

(57) ABSTRACT

Hydrating beverages for animals, especially humans, comprising electrolytes and a lactate and the method of rehydrating animals, especially humans, by administering said beverages before, during, or after dehydration.

### BACKGROUND OF THE INVENTION

The present invention relates to hydrating beverages and to the method of enhancing hydration in animals, particularly humans.

It has long been known that glycerol can be used to enhance hydration in humans and other animals suffering from the dehydration effects of physical exertion, exposure to above normal heat, hydration stress, and the like. The use of glycerol acts to prolong fluid retention and thus have water available for sweating, cell hydration, and maintenance of blood plasma volume.

Beverages utilized to hydrate humans for exercise purposes are commonly referred to as “sports drinks”.

The use of electrolytes alone or in conjunction with sweetener and water was originally used for hydration, but it was found that the use of a glycerol therewith provided superior hydrating effects.

In some instances where enhanced exercise endurance and performance are desired, such glycerol-containing solutions are taken prior to and during exercise as well as after exercise.

While generally satisfactory, all of these prior art electrolyte and glycerol-containing solutions and beverages are not totally effective for a variety of reasons.

One is that such prior art compositions fail to address the problem of muscle fatigue. It is known that one of the results of exercise, both during and after exercise, is muscle fatigue. The glycerol, sugar and level of potassium previously used do not address the attenuation of such muscle fatigue.

Potassium is known to play a major role in overcoming the effects of muscle fatigue since substantial amounts thereof are lost from the contracting muscles during exercise and there is also a rapid decrease in plasma potassium after the cessation of exercise. Present hydrating fluids and beverages containing glycerol contain low levels of potassium, and they fail to provide a level of potassium sufficient to maintain an adequate blood plasma level of potassium to combat muscle fatigue.

U.S. Pat. No. 6,485,764 addresses and overcomes this problem as well as others in this art. The entire specification and claims, including the references cited therein, are hereby incorporated by reference in this application.

While suitable, it has been noted that for certain individuals, particularly those who are taking certain medications, the increased potassium may lead to hyperkalemia.

While mild hyperkalemia is well tolerated, higher levels of hyperkalemia can lead to symptoms such as nausea, fatigue, muscle weakness, diarrhea, and an irregular heartbeat and, possibly, more serious consequences.

Even with low levels of potassium, certain drugs can cause hyperkalemia. For example, use of beta blockers, potassium sparing diuretics, nonsteroidal anti-inflammatory drugs (NSAIDs), and ACE inhibitors, when combined with potassium, can lead to hyperkalemia.

Since many persons taking the above-noted drugs often do strenuous exercises and utilize hydrating beverages having high levels of potassium without first consulting a doctor, they are risking the possibly severe symptoms of hyperkalemia.

In addition, recent studies state that artificial colorings and benzoate preservatives can be unsuitable for young children by causing hyperactivity. Also, there is mounting scientific evidence for the risk of sodium benzoate reacting with ascorbic acid to form benzene, a known carcinogen. Some scientists believe that ingestion of sodium benzoate may speed the process of aging, leading to enhanced rates of cell DNA damage, Parkinson's disease and other degenerative diseases of the nervous system.

While there is no evidence of detrimental function of the other known preservatives used in the beverage industry, such as potassium sorbate, the fact remains that potassium sorbate is not a naturally occurring metabolite in the body. Furthermore, the combination of potassium sorbate with sodium benzoate causes a “metallic” or bitter aftertaste to beverages.

Given the prevalence of soda and other beverage intake by US adults and children, with increased retail beverage intake by children in recent decades, there is a health need for all Americans to decrease ingestion of non-naturally occurring preservatives while devising a formulation that still affords anti-microorganism protection to the beverage. While glycerol is a naturally occurring material, it has a high caloric value and is undesirable for inactive adults and children, particularly those who are obese.

### BRIEF SUMMARY OF THE INVENTION

The present invention provides hydrating beverages and a method for enhancing hydration in animals, preferably humans, both with reduced levels and absence of artificial preservatives while still preserving its hydration, cramp protection, and drink protection against microorganisms, such as bacteria and fungii.

Briefly and broadly stated, the present invention comprises a hydration beverage comprising glycerol, electrolytes, and an edible source of a lactate, and preferably an acetate. As used herein, the term “edible” means constituents approved for human and/or animal consumption. It is also preferred to include, as noted, an acetate that is a naturally occurring metabolite in the body.

The instant hydration beverage can be used as a concentrate, without the addition of water or preservative, and distributed to bottlers who add water and preservatives (if desired) to produce ready-to-drink (off the shelf) products. Also, it can be distributed as a concentrate to end users, such as sports teams, where the necessary water can be added to form the beverage. Such teams commonly use coolers where the beverage is prepared in its final form the day it is to be produced and is available on the training or game site. The contents of such coolers are commonly disposed of after the day's training or game, sometimes by being poured on the winning coach at game's end. Such prompt use eliminates the need for a preservative.

Further, the glycerol and lactate in the drink provide natural preservative functions without need for artificial additives. Thus, even the final solution, in its diluted ready to drink form, will have significant shelf life, and an acetate can be added to ensure additional anti-microorganic protection.

The invention also comprises the method of enhancing hydration in animals, preferably humans, as hereinafter described.

### DETAILED DESCRIPTION OF THE PREFERRED EMBODIMENTS

While the instant invention is applicable to animals generally, such as the horse, it will be further discussed and described with respect to humans and hydration of humans at rest, during exercise, and after exercise/dehydration. It will also be further discussed in connection with enhanced hydration in exercise situations. Such hydrating beverages, as noted above, are commonly referred to as “sports drinks”. Also, all the constituents of the beverages are those approved for human and/or other animal consumption.

It has been discovered that lactates can be used in hydrating beverages to decrease reductions in potassium efflux from exercising muscle, thereby delaying or preventing such muscle fatigue and cramps. This eliminates the need to increase the amounts of potassium added to hydration beverages and even to lower the amount without losing the benefits of the potassium. Both potassium and sodium are important electrolytes for optimal nerve and muscle function. Each electrolyte has a single positive charge, and during muscle contraction, sodium moves into muscle cells and dramatically increases the charge inside the cell. The cell increases potassium efflux to help deal with this developing charge discrepancy. The added ingestion of lactate allows increased muscle lactate accumulation. As lactate has a negative charge, this opposes the developing increase in charge inside the cell, and lessens the need for potassium efflux. As such, lactate ingestion in a sports drink can better maintain a more normal charge inside the muscle cell and conserve muscle potassium.

Further, as used herein, the term “edible” means ingredients, such as lactate and preservatives, approved for use by humans and other animals. Examples of suitable lactates are sodium lactate, calcium lactate, ferrous lactate, potassium lactate, magnesium lactate, zinc lactate, and the like.

Suitable preservatives are sodium benzoate and potassium sorbate, but, as noted above, these have drawbacks. Instead, sodium di-acetate and potassium lactate can be added to the drink for preservation. When these compounds are added to citric acid and the glycerol, the drink has adequate natural preservative content.

The proportions of ingredients for making concentrates and ready-to-drink beverages are set forth in the tables that follow.

### Concentrate

| | Operative Range | Preferred Range |
|---|---|---|
| | in % by wt. | in % by wt. |
| Water | balance (0.45) | balance (0.45) |
| Glycerol | 35-75 | 42.5 |
| Sweetener | 30-80 | 40-50 |
| Sodium Salts | 0.05-0.15 | 0.1 |
| Potassium Salts | 0.025-0.1 | 0.07 |
| Lactates | 3-6 | 5 |
| Acetates | 3-6 | 5 |
| Citrates | 3-6 | 5 |
| Anti-oxidants | 0.05-.125 | 0.096 |

### Ready-to-Drink Beverages

| | Operative Range | Preferred Range |
|---|---|---|
| | in % by wt. | in % by wt. |
| Water | 4.5 | 4.5 |
| Glycerol | 3.5-7.5 | 3.5-7.5 |
| Sweetener | 3-10 | 4-8 |
| Sodium Salts | 0.005-0.015 | 0.01 |
| Potassium Salts | 0.0025-0.001 | 0.007 |
| Lactates | 0.1-0.3 | 0.1-0.3 |
| Acetates | 0.1-0.2 | 0.1-0.2 |
| Citrates | 0.1-0.2 | 0.1-0.2 |
| Anti-oxidants | 0.05-0.125 | 0.096 |
| Preservative | 0.1-0.5 | 0.2-0.3 |

These are all 10-fold dilutions of the concentrate for purposes of manufacturing convenience. Also, the source of the sweetener, if used, is one that also contains water, and note that glycerol is a liquid. Hence the low % of water above.

As to the sweetening agent used, any sugar or sweetening material conventionally used in rehydrating beverages can be utilized and in their usual concentrations. Examples are glucose, sucrose, high fructose corn syrup, mixtures thereof, and the like. For dietetic beverages the known artificial sweeteners can be substituted for the agents. Since many who exercise do not want to ingest excess calories, the level of sugars can be kept low, preferably about 2 to 4% by weight of the beverage. However, there are often exercise related needs for the ingestion of greater levels of carbohydrates, especially in the recovery from long duration exercise where carbohydrate (glucose) is needed to replace muscle glycogen. In such instances a range up to about 12% carbohydrate by weight can be utilized to meet this increased need.

The glycerol is also that conventionally used, and the amounts thereof can vary widely. While amounts up to 6% by weight or higher can be used, it has been found that for a small number of individuals such a level of glycerol can cause headaches, blurred vision, light-headedness, and/or nausea. Further, for purposes of taste it has been found that the higher levels of glycerol tend to give the beverage an unpleasant aftertaste. Accordingly, in order to avoid certain undesired symptoms for some and an unpleasant taste, it is preferred to maintain the glycerol concentration below 5%/by weight, even as low as 3.5 wt. %. As is the case with all glycerol containing hydrating beverages, it is preferred that the beverage be hypertonic.

As previously noted, another result of exercise is the greatly increased production of destructive free radicals which are harmful. To negate such harmful effects, it is preferred to include at least one edible antioxidant in the beverage which will react readily with the free radicals and destroy them before they can damage the body.

Suitable antioxidants include vitamins A, C, and E, beta carotene, selenium, coenzyme Q 10, pycnogenol, L-glutathione, superoxide dismutase, bioflavonoids, and antioxidants found in plants such as garlic. Of these, vitamin C (ascorbic acid) is preferred because it has the additional benefit of acting as a buffer in the beverages, thereby combating acidosis.

The amounts of antioxidant use can vary widely, but care must be taken to ensure that the amount of antioxidant used does not adversely affect the taste of the beverage.

It will be evident that the amount of water added is that required to provide the proper concentration of the active components for the size of the container for the beverage. Normally, such beverages, as with other sports drinks, come in a container holding at least about 8 fluid ounces of the beverage.

The beverage can also contain, as is usual in these beverages, the already noted citric acid, natural and artificial flavors, preservatives, natural and artificial colors and the like, in their usual proportions for their usual effects.

The method of the instant invention is largely evident from the foregoing description. For enhanced rehydration at rest, during exercise, and after exercise/dehydration, an average human being need only ingest, after dehydration due to exercise and/or thermal stress, a beverage of the instant invention described above containing the active components thereof. It will be evident that the volume and rate of beverage needed to be ingested increases with the risk for or severity of dehydration. As is known, the amount ingested is related to the fluid volume needed to maintain normal body weight. This is highly individual and may require ingestion of between 8 and 24 fluid ounces of the beverage every hour during the dehydration stress. Also, when concerned with rehydration, it has been more effective to ingest a volume of beverage about 1.5 times the weight loss from dehydration rather than the usual ingestion of a fluid volume equal to the weight loss from dehydration.

Again, as is common with rehydrating beverages, the instant compositions may be prepared in concentrate liquid form to be reconstituted by the user by the addition of water. Such reconstitution is made with the requisite amounts of water to ensure that the beverage to be consumed contains the active components in the proportions previously noted.

The best mode contemplated for carrying out the invention that is known at this time is further described in connection with the following examples which are set forth for purposes of illustration only.

### Example 1

A concentrate is made from the following:

| | Grams to make 1 Liter |
|---|---|
| Water | 45 |
| Glycerol | 438 |
| *High Fructose Corn Syrup | 500 |
| Sodium Chloride | 0.1 |
| Potassium Acetate | 0.05 |
| Sodium Lactate | 10 |
| Sodium Acetate | 0.5 |
| Sodium Citrate | 1 |
| Ascorbic acid | 1 |

*typically 70% solids and 30% water

The concentrate was prepared by simply admixing the ingredients and bottling them in the conventional apparatus used for such purposes.

### Example 2

A ready-to-drink beverage is prepared by diluting the concentrate of Example 1 and adding a preservative.

| | Final concentration after a 10-fold dilution |
|---|---|
| | (= 1 part concentrate + 9 parts water) |
| | % by wt. |
| Water | — |
| Glycerol | 3.5 |
| High Fructose Corn Syrup* | 3.5 |
| Sodium Chloride | 0.01 |
| Potassium Acetate | 0.05 |
| Sodium Lactate | 0.1 |
| Ascorbic Acid | 0.05 |
| Sodium Citrate | 0.1 |
| Potassium Sorbate | 0.02 |

### Example 3

A series of ready-to-drink beverages is made by substituting equivalent amounts of calcium lactate, ferrous lactate, potassium lactate, magnesium lactate, and zinc lactate separately and in turn for the sodium lactate used in Example 2. Equally suitable drinks are prepared.

### Example 4

A series of ready-to-drink beverages is made by substituting equivalent amounts of sodium acetate, sodium di-acetate, separately and in turn for the potassium acetate used in Example 2. Equally suitable drinks are prepared.

### Example 5

A low caloric drink is prepared using the ingredients of Examples 2 to 4, but replacing the high fructose corn syrup, separately and in turn, with sucralose and aspartamine. Suitable dietetic drinks are formed.

### Example 6

A sugar sweetened drink without high fructose corn syrup is prepared using the ingredients of Examples 2 to 4, but replacing the high fructose corn syrup, separately and in turn, with either sucrose (table sugar), glucose, fructose, or mixtures thereof. Suitable flavored drinks are formed.

This drink can use natural low calorie fruit flavorings to make a fully natural hydrating beverage giving the natural ingredients beneficial for good health.

The beverages and methods of the instant invention are ideally suited to anyone exposed to above-normal heat or hydration stress, such as those living in hot or humid climates, factory workers, armed forces personnel, police, firemen, and the like, in addition to those who engage in exercise.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A hydrating beverage for animals comprising electrolytes and a lactate.

2. The hydrating beverage of claim 1 including an acetate.

3. The hydrating beverage of any one of claims 1 or 2 containing a glycerol.

4. A hydrating beverage of any one of claims 1 to 3 which also contains water and edible, naturally occurring preservatives suitable for use in such beverages.

5. The hydrating beverage of any one of claims 1 to 4 including an antioxidant.

6. The hydrating beverage of any one of claims 1 to 5 including ascorbic acid.

7. A hypertonic hydrating beverage for humans consisting essentially of water, a sweetening agent, glycerol, sodium, and potassium, a lactate, and an acetate.

8. The hydrating beverage of any one of claim 7, including an antioxidant.

9. The hydrating beverage of claim 7 or 8, including ascorbic acid.

10. The method of enhancing rehydration of an animal after rest, during exercise, and after exercise/dehydration comprising administering to said animal a hypertonic beverage comprising water, sodium, potassium and a lactate, said potassium being present in an amount sufficient to provide in the blood plasma of said animal a potassium level of between about 5 to 8 meq/l and excretion of potassium in the urine after ingestion.

11. The method of claim 10 wherein the beverage also contains an acetate.

12. The method of claim 10 wherein the beverage also contains a glycerol.

13. The method of claim 10, wherein the potassium is present in the beverage in an amount of at least about 6 meq/l.

14. The method of claim 10, wherein the volume of beverage ingested is at least equal to the weight loss from dehydration.

15. The method of claim 14, wherein the volume is 1.5 times the weight loss from dehydration.

16. The method of any one of claims 10 to 15 wherein the beverage is ingested at the rate of between 8 to 48 fluid ounces every hour.
